(19) United States
(12) Patent Application Publication
(10) Pub. No.: US 2025/0247749 A1
(43) Pub. Date: Jul. 31, 2025

(54) Methods And Apparatus Of Security Update For Layer 1/Layer 2 Triggered Mobility In Inter-Central Unit Scenario In Mobile Communications

(71) Applicant: MediaTek Singapore Pte. Ltd., Singapore (SG)

(72) Inventors: Xiaonan Zhang, Beijing (CN); Yuanyuan Zhang, Beijing (CN)

(21) Appl. No.: 19/034,560

(22) Filed: Jan. 23, 2025

(30) Foreign Application Priority Data
Jan. 26, 2024 (WO) PCT/CN2024/074222
Jan. 13, 2025 (CN) 202510051966.6

(51) Int. Cl. H04W 36/00; H04W 12/03; H04W 12/041; H04W 36/04

(52) U.S. Cl. CPC H04W 36/0038; H04W 12/03; H04W 12/041; H04W 36/04

(57) ABSTRACT

Various solutions for security update for secondary cell group (SCG) layer 1/layer 2 triggered mobility (LTM) in inter-central unit (CU) scenario in mobile communications are described. A UE may receive an LTM configuration associated with a secondary cell group (SCG) from a network node. Also, the UE may obtain a security key for a target secondary node (SN), in which the security key for the target SN is calculated based on the LTM configuration. Further, the UE may transmit at least one message encrypted with the security key to the target SN. In this way, the security update for inter-CU SCG LTM can be supported.

### CROSS REFERENCE TO RELATED PATENT APPLICATION(S)

The present disclosure is part of a non-provisional application claiming the priority benefit of PCT Application No. PCT/CN2024/074222, filed 26 Jan. 2024, and CN Application No. 202510051966.6, filed 13 Jan. 2025. The contents of aforementioned applications are herein incorporated by reference in their entirety.

### TECHNICAL FIELD

The present disclosure is generally related to mobile communications and, more particularly, to security update for secondary cell group (SCG) layer 1/layer 2 triggered mobility (LTM) in inter-central unit (CU) scenario with respect to user equipment and network apparatus in mobile communications.

### BACKGROUND

Unless otherwise indicated herein, approaches described in this section are not prior art to the claims listed below and are not admitted as prior art by inclusion in this section.

In mobile communications, handover refers a process of transferring an ongoing communication session of a user equipment (UE) from one cell to another in connected state, such that seamless connectivity and continuity of service for the user can be ensured, especially when the user is on the move. In legacy handover (e.g., a type of cell switch) specified in 3^{rd} Generation Partnership Project (3GPP) Release 17, a serving cell switch is triggered by layer 3 (L3) measurements with radio resource control (RRC) signaling for switching from a serving cell to a target cell. This L3 based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time. Advanced to Release 18, a lower layer triggered mobility (also called layer 1 (L1)/layer 2 (L2) triggered mobility, LTM) is introduced to enable the cell switch procedure via L1 or L2 signaling, which can keep configuration of the upper layers and/or minimize changes of configuration of the lower layers for reducing latency during the cell switch procedure.

In an LTM procedure, LTM preparation and early synchronization are performed prior to LTM cell switch execution. When the condition is met, a cell switch command is indicated to UE to trigger the cell switch procedure. During the preparation stage, configurations toward candidate cells are pre-configured by an RRC message. However, as the current L1/L2 based inter-central unit (CU) mobility does not support security update, there is a need to develop solutions for the corresponding procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to security update for secondary cell group (SCG) layer 1/layer 2 triggered mobility (LTM) in inter-central unit (CU) scenario with respect to user equipment (UE) and network apparatus in mobile communications.

In one aspect, a method may involve an apparatus receiving an LTM configuration associated with an SCG from a network node. The method may also involve the apparatus obtaining a security key for a target secondary node (SN). The security key for the target SN is calculated based on the LTM configuration. The method may further involve the apparatus transmitting at least one message encrypted with the security key to the target SN.

In one aspect, an apparatus may comprise a transceiver which, during operation, wirelessly communicates with a network. The apparatus may also comprise a processor communicatively coupled to the transceiver. The processor, during operation, may perform operations comprising receiving, via the transceiver, an LTM configuration associated with an SCG from a network node. The processor may also perform operations comprising obtaining a security key for a target SN, in which the security key for the target SN is calculated based on the LTM configuration. The processor may further perform operations comprising transmitting, via the transceiver, at least one message encrypted with the security key to the target SN.

In another aspect, a method may involve a network node configuring at least one candidate SN for a UE. The method may also involve the network node transmitting an LTM configuration associated with an SCG to the UE. The LTM configuration may include at least one sk-counter list for a security update for the candidate SN.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with implementations of the present disclosure.

FIG. 2 is a diagram depicting an example scenario of inter-central unit (CU) secondary cell group (SCG) layer 1/layer 2 triggered mobility (LTM) in accordance with implementations of the present disclosure.

FIG. 3 is a diagram depicting an example scenario of security update in accordance with an implementation of the present disclosure.

FIG. 4 is a diagram depicting another example scenario of security update in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to security update for secondary cell group (SCG) layer 1/layer 2 triggered mobility (LTM) in inter-central unit (CU) scenario in mobile communications. According to the present disclosure, a number of possible solutions may be implemented separately or jointly. That is, although these possible solutions may be described below separately, two or more of these possible solutions may be implemented in one combination or another.

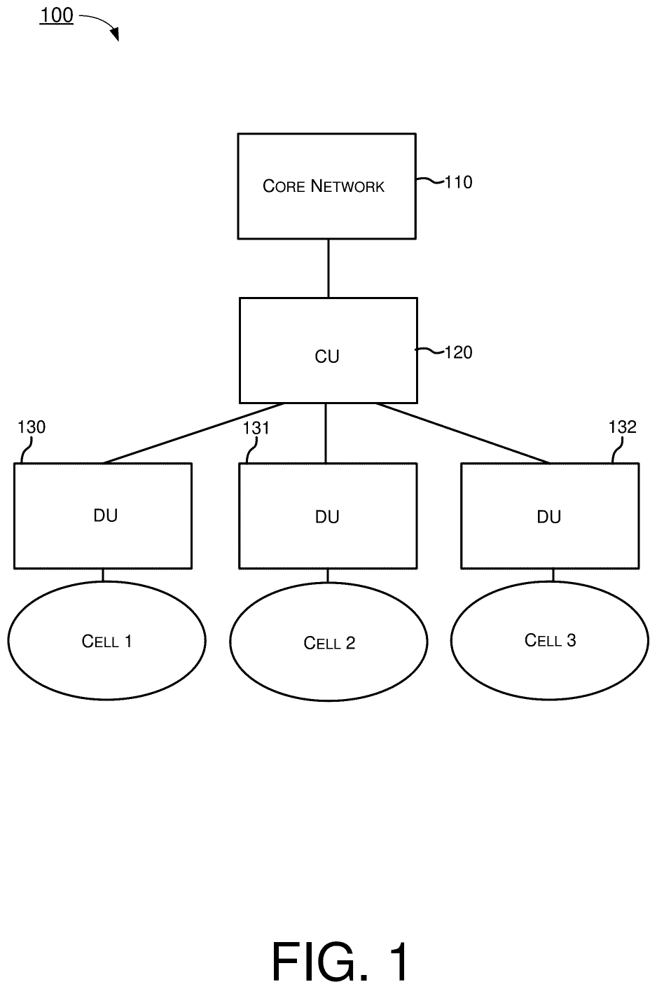

FIG. 1 illustrates an example mobile communication network 100 in accordance with an implementation of the present disclosure. As shown in FIG. 1, the mobile communication network 100 supports various wireless communication services and may be functionally operated with different protocol split options among at least a core network 110 and a plurality of BSs, e.g., evolved NodeBs (eNBs), next generation NodeBs (gNBs), or transmission and reception points (TRPs). In some implementations, the plurality of BSs may be gNBs implemented as a central unit (CU) 120 and distributed units (DUs) 130-132 associated with serving coverages/cells (e.g., Cells 1-3). In some implementations, service data application protocol (SDAP) and packet data convergence protocol (PDCP) layers may be located in the CU 120, and radio link control (RLC), medium access control (MAC) and physical (PHY) layers may be located in the DUs 130-132.

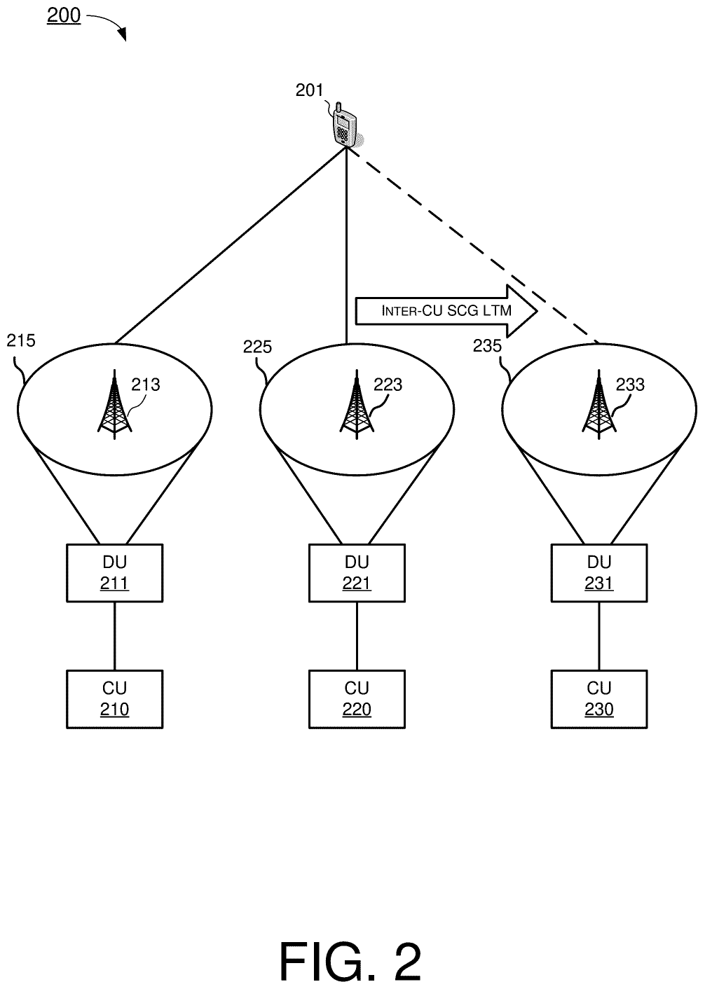

FIG. 2 is a diagram depicting an example scenario of inter-CU SCG LTM in accordance with implementations of the present disclosure. As shown in FIG. 2, the CUS 210-230 are connected to the DUs 211-231, respectively. The DUs 211-231 are connected to the radio units (RUs) 213-233, respectively. Each of the cells 215-235 may consist of a range covered by the corresponding RUs 213-233. In this embodiment, the RU 213 provides the control plane connection to the core network in case of multi radio dual connectivity (MR-DC), thus the RU 213 is referred to as the master node (MN) 213. The RUs 223 and 233 provide additional resources to the UE 201 in case of MR-DC, and are referred to as the secondary nodes (SNs) 223 and 233. The SNs 223 and 233 may belong to the same or different radio access technologies (RATs). The protocol stack including PDCP, RLC, and MAC is different in any two of the CUS 210-230 and corresponding DUs 211-231.

In scenario 200, a procedure of inter-CU SCG LTM is supported. The UE 201 may move from the edge of one cell to another cell, in which the source cell and the target cell belong to different CUs. For example, the UE 201 may switch from the SN 223 belonging to the CU 220 to the SN 233 belonging to the CU 230. In one embodiment, the SCG LTM is initiated by an SN (e.g., the SN 223) without the involvement of the MN 213. For example, a signaling radio bearer 3 (SRB 3) signaling is used for the SN-initiated SCG LTM and the signaling is transferred from the SN 223 to the UE 201. Alternatively, the SRB3 signaling is used for the SN-initiated SCG LTM and the signaling is transferred from the SN 223 to the MN 213, then transferred from the MN 213 to the UE 201. Signaling can originate from either the SN 223 or the UE 201 and terminate at the opposite end, regardless of SRB3 usage.

During the inter-CU SCG LTM, the UE 201 may receive an LTM configuration associated with an SCG (also referred to as the SCG LTM configuration) from the source SN 223. The SCG LTM configuration may be an RRC reconfiguration message, which includes the SCG configuration such as one or more candidate SNs and one or more security key counter (sk-counter) lists for SCG handover. Further, the SCG LTM configuration may include an indication indicating whether a candidate SN belongs to a different CU. The UE 201 may obtain the security key for the target SN 233 calculated based on the SCG LTM configuration. In one example, the SCG LTM configuration may include only one sk-counter list. The single sk-counter list may be associated with all candidate SN(s) of the UE 201. For example, the single sk-counter list may be associated with one candidate SN if there is only one candidate SN for the UE 201, or the single sk-counter list may be associated with multiple candidate SNs if there are multiple candidate SNs for the UE 201. Alternatively, the SCG LTM configuration may include one or more candidate SN-based sk-counter lists, and each candidate SN-based sk-counter list is associated with one candidate SN. More specifically, the sk-counter list may include one or more sk-counters (or referred to as the sk-counter values), and the security key for the target SN 233 may be calculated based on a MN security key (e.g., the security key of the MN 213) and one sk-counter selected from the sk-counter list. In one embodiment, the security key for the target SN 233 is calculated based on the MN security key and the first unused sk-counter in the sk-counter list. Further, the UE 201 may derive an RRC encryption key (i.e., KRRCenc) and a user plane (UP) encryption key (i.e., KUPenc) for ciphering and integrity protection algorithms from the security key for the target SN 233. The UE 201 may transmit a message (e.g., an RRC reconfiguration RRC reconfiguration complete message), encrypted with the security key obtained for the target SN 233, to the target SN 233 upon the inter-CU SCG LTM cell switch is completed.

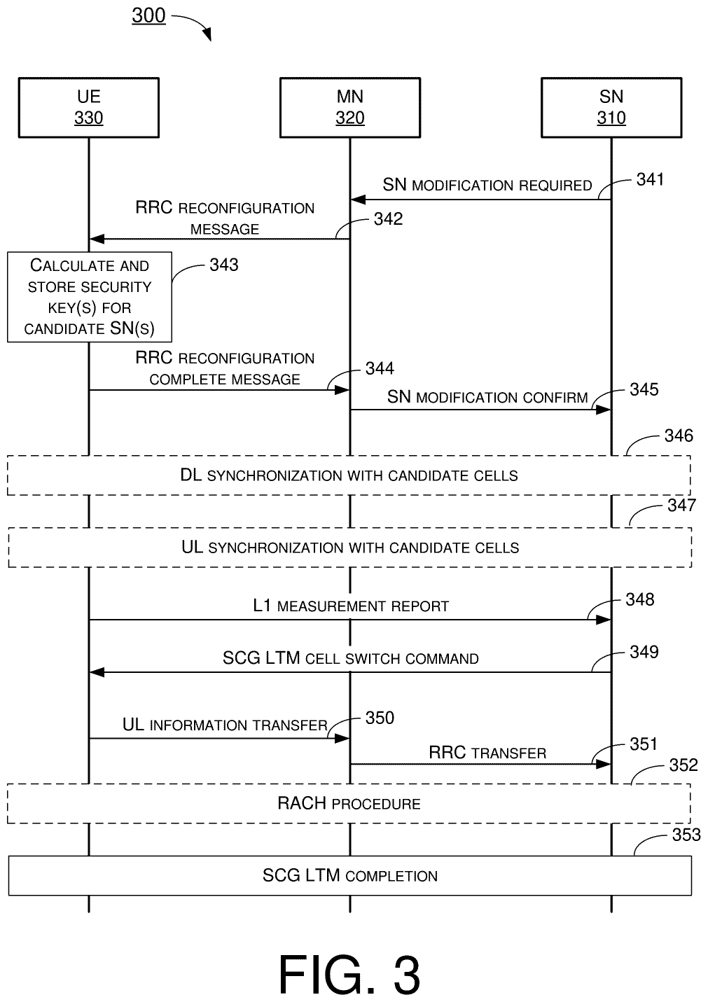

FIG. 3 is a diagram depicting an example scenario of security update in accordance with an implementation of the present disclosure. In scenario 300, the SCG LTM is initiated by the SN 310 without the involvement of the MN 320. In the SCG LTM preparation stage as shown in operations 341 to 345, the SN 310 initiates the SCG LTM procedure and an RRC reconfiguration message including the SCG LTM configuration is forwarded to the UE 330. In one embodiment, an indication is included in the SCG LTM configuration per candidate SN to indicate whether the candidate SN belongs to a different CU. Before knowing which candidate SN is the target SN, as shown in operation 343, the UE 330 may calculate and store the secondary key for each candidate SN based on the sk-counter included in the SCG LTM configuration and security key of the MN 320. In one embodiment, the SCG LTM configuration includes one sk-counter list for all candidate SN(s) (i.e., the sk-counter list is provided per UE). The sk-counter selected for calculating a security key is the first unused sk-counter in the sk-counter list. In one example, all candidate SN(s) correspond to the same security key. That is, the UE 330 performs one calculation in operation 343 and the result (i.e., the security key) can be used for any target SN. In another embodiment, the SCG LTM configuration includes one or more candidate SN-based sk-counter lists, and each candidate SN-based sk-counter list is associated with one candidate SN (i.e., the sk-counter list is provided to UE per SN). The UE 330 calculates the security key for each candidate SN based on the first unused sk-counter in the corresponding sk-counter list. That is, the UE 330 performs the calculation for each candidate SN in operation 343, so that each candidate SN has its own security key. In the early synchronization stage as shown in operations 346 and 347, the UE 330 may perform a downlink (DL) synchronization and an uplink (UL) synchronization with the candidate cells (e.g., the candidate SNs). In the SCG LTM execution stage as shown in operations 348 to 352, the UE 330 may transmit an L1 measurement report to the SN 310, and receive an SCG LTM cell switch command (e.g., an SCG LTM cell switch command MAC CE) from the SN 310. In this embodiment, the target SN is indicated by the SCG LTM cell switch command. The UE 330 may obtain the security key for the target SN from the security keys previously calculated and stored in operation 343. In the SCG LTM completion stage as shown in operation 353, the UE 330 may generate an RRC reconfiguration complete message which is then forwarded to the target SN for LTM completion. The RRC reconfiguration complete message is encrypted with the security key of target SN. As shown in FIG. 3, the security key(s) for all candidate SN(s) may be per-calculated and stored during the LTM preparation stage. This means that scenario 300 is applicable in cases where the fast RRC processing feature is performed.

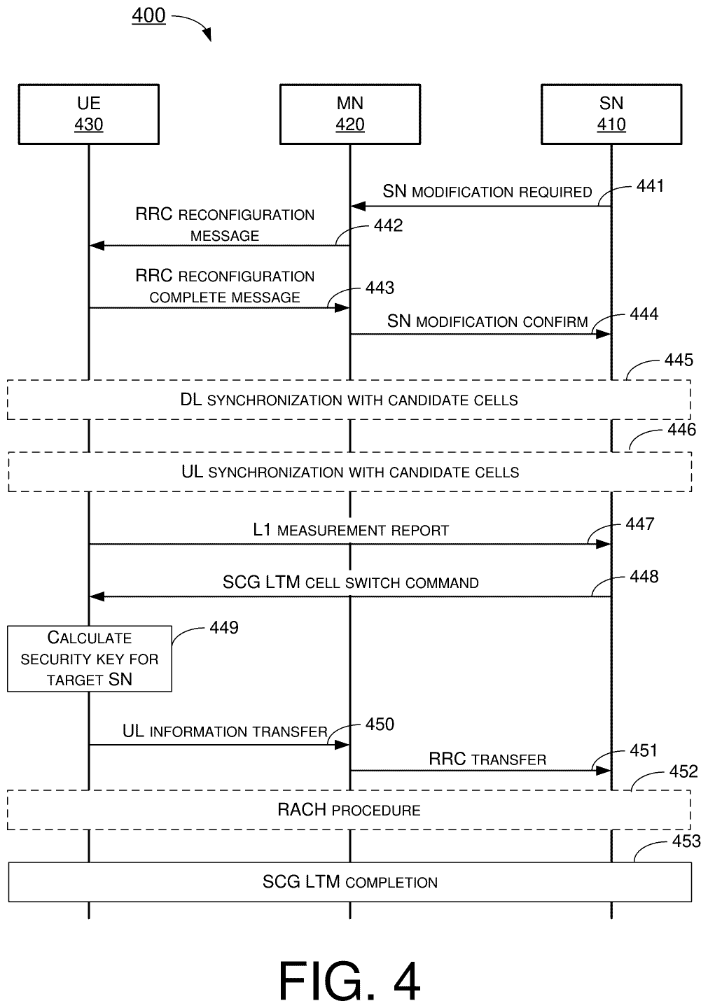

FIG. 4 is a diagram depicting another example scenario of security update in accordance with an implementation of the present disclosure. In scenario 400, the SCG LTM is initiated by the SN 410 without the involvement of the MN 420. In the SCG LTM preparation stage as shown in operations 441 to 444, the UE 430 receives an RRC reconfiguration message including the SCG LTM configuration, such as a list of candidate SN(s) and at least one sk-counter list. In one example, the SCG LTM configuration includes one sk-counter list for all candidate SN(s). In another example, the SCG LTM configuration includes one or more candidate SN-based sk-counter lists, and each candidate SN-based sk-counter list is associated with one candidate SN. In the early synchronization stage as shown in operations 445 and 446, the UE 430 may perform a DL synchronization and a UL synchronization with the candidate cells (e.g., the candidate SNs). In the SCG LTM execution stage as shown in operations 447 to 452, the UE 430 receives an SCG LTM cell switch command (e.g., an SCG LTM cell switch command MAC CE) from the SN 410, which indicates the target SN to be switched to. As shown in operation 449, the UE 430 may calculate the security key for the target SN upon receiving the SCG LTM cell switch command. For example, the UE 430 may calculate the security key for the target SN based on the security key of the MN 420 and the first unused sk-counter in the corresponding sk-counter list. In one embodiment, the UE 430 may remove the sk-counter currently used from the sk-counter list after calculating the security key for the target SN and calculate another security key for the subsequent SCG LTM based on the next unused sk-counter in the sk-counter list(s). For instance, if all candidate SN(s) share the same sk-counter list, and this list includes unused sk-counters A1, A2, and A3. After calculating the security key for the target SN using unused sk-counter A1, it is removed from the list. Subsequently, unused sk-counter A2 is used to calculate another security key for the next SCG LTM. When each candidate SN has its own distinct sk-counter list, the first unused sk-counter in another sk-counter list is used for the next SCG LTM. For example, if the LTM configuration includes sk-counter lists A and B, in which sk-counter list A includes unused sk-counters A1, A2, and A3, and sk-counter list B includes unused sk-counters B1, B2, and B3. If the UE 430 calculates the security key for the target SN using unused sk-counter A1, it is then removed from sk-counter list A. The UE 430 may further calculate another security key for the next SCG LTM using sk-counters B1 in the sk-counter list B. The calculation of the security key for the next target SN may be performed when the UE 430 receives the indication for the subsequent SCG LTM. Alternatively, the UE 430 may calculate and store the security key for the next target SN in the subsequent SCG LTM preparation stage. In the SCG LTM completion stage as shown in operation 453, the UE 430 may generate an RRC reconfiguration complete message encrypted with the security key and transmit the encrypted RRC reconfiguration complete message to the target SN.

Although the forgoing embodiments focus on the inter-CU SCG LTM, it should be noted that the security update procedure for the SCG LTM can be used in the intra-CU scenario as well as the inter-CU scenario. In the present disclosure, the term SNs may be referred to different BSs or different cells of the same CU/DU. The security key for the MN may also be referred to as a KgNB, a kgNB, a KgNB, a KNG-RAN, or by other terminology used in the art. The security key for the target SN may also be referred to as an S-KgNB, an s-kgNB, an S-KNG-RAN, a secondary key, or by other terminology used in the art. The sk-counter list may also be referred to as an sk-counter value list, or by other terminology used in the art. The SCG LTM cell switch command MAC CE may also be referred to as an SCG cell switch command MAC CE, SCG LTM cell switch MAC CE, SCG LTM cell switch command or by other terminology used in the art. The RRC reconfiguration message used in the SCG LTM preparation stage may also be referred to as a pre-configuration message, an SCG LTM configuration message, an SCG LTM pre-configuration message or by other terminology used in the art.

Based on the foregoing embodiments, the security update can be supported in the Inter-CU SCG LTM. Compared with the legacy SCG mobility, the Inter-CU SCG LTM with security enhancement may reduce the interruption and signaling overhead and improve the throughput of UE.

### Illustrative Implementations

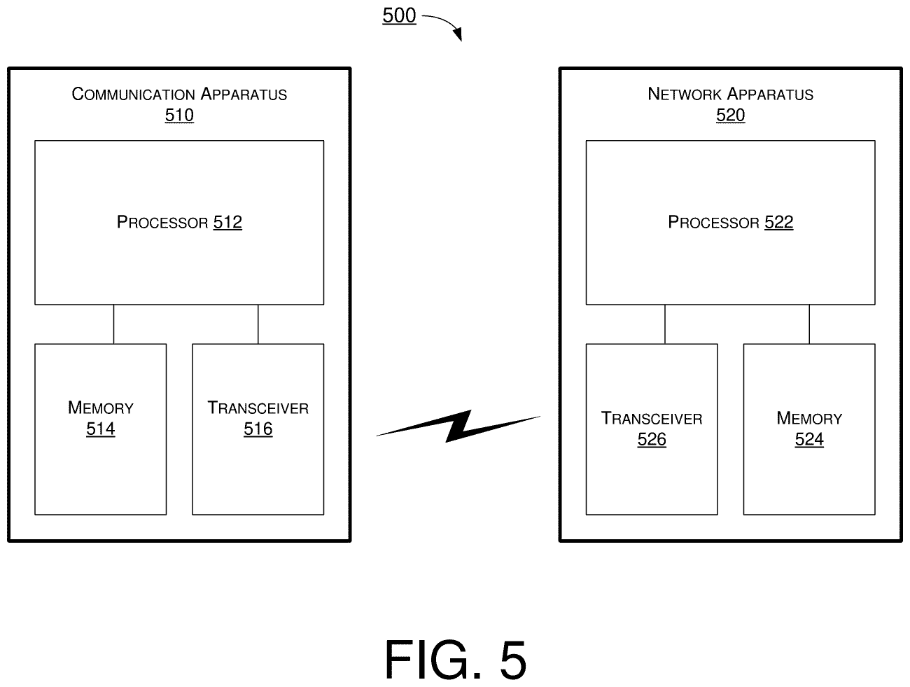

FIG. 5 illustrates an example communication system 500 having at least an example communication apparatus 510 and an example network apparatus 520 in accordance with an implementation of the present disclosure. Each of the communication apparatus 510 and network apparatus 520 may perform various functions to implement schemes, techniques, processes and methods described herein pertaining to security update for SCG LTM in inter-CU scenario in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNB in an LTE network, in a gNB in a 5G/NR, IoT, NB-IoT or IIoT network or in a satellite or base station in a 6G network. Network apparatus 520 may include at least some of those components shown in FIG. 5 such as a processor 522, for example. Processor 522 may further include protocol stacks and a set of control functional modules and circuits. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of the processor 512 and processor 522 may be implemented in the form of one or more single-core processors, one or more multi-core processors, or one or more CISC processors. That is, even though a singular term “a processor” is used herein to refer to processor 512 and processor 522, each of the processor 512 and processor 522 may include multiple processors in some implementations and a single processor in other implementations in accordance with the present disclosure. In another aspect, each of the processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and processor 522 is a special-purpose machine specifically designed, arranged and configured to perform specific tasks in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein.

In some implementations, network apparatus 520 may further include a transceiver 526 coupled to processor 522 and capable of wirelessly transmitting and receiving data, and a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

For illustrative purposes and without limitation, descriptions of capabilities of the communication apparatus 510 and network apparatus 520 are provided below with process 600 and process 700. In which, communication apparatus 510 is implemented in or as a communication apparatus or a UE, and network apparatus 520 is implemented in or as a network node of a communication network (e.g., a base station).

### Illustrative Processes

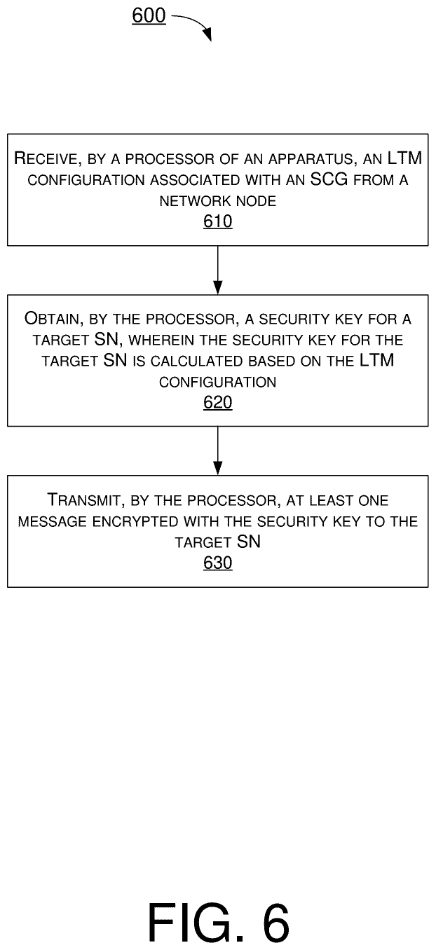

FIG. 6 illustrates an example process 600 in accordance with an implementation of the present disclosure. Process 600 may be an example implementation of above scenarios/schemes, whether partially or completely, with respect to security update for SCG LTM in inter-CU scenario in mobile communications. Process 600 may represent an aspect of implementation of features of communication apparatus 510. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510 as a UE. Process 600 may begin at block 610.

At block 610, process 600 may involve processor 512 of communication apparatus 510 receiving, via transceiver 516, an LTM configuration associated with an SCG from a network node (e.g., network apparatus 520). Process 600 may proceed from block 610 to block 620.

At block 620, process 600 may involve processor 512 obtaining a security key for a target SN. The security key for the target SN is calculated based on the LTM configuration. Process 600 may proceed from block 620 to block 630.

At block 630, process 600 may involve processor 512 transmitting, via transceiver 516, at least one message encrypted with the security key to the target SN.

In some implementations, the LTM configuration may include one sk-counter list associated with one or more candidate SNs.

In some implementations, the LTM configuration may include at least one sk-counter list, and each sk-counter list is associated with one candidate SN.

In some implementations, the security key for the target SN is calculated based on an MN security key and one sk-counter selected from an sk-counter list included in the LTM configuration.

In some implementations, the selected sk-counter is a first unused sk-counter in the sk-counter list.

In some implementations, process 600 may further involve processor 512 calculating a plurality of security keys for a plurality of candidate SNs during an LTM preparation stage. Also, process 600 may involve processor 512 storing the plurality of security keys. The security key for the target SN is obtained from the stored plurality of security keys.

In some implementations, the obtaining of the security key for the target SN further may include calculating the security key for the target SN in an event that receiving an SCG LTM cell switch command from the network node.

In some implementations, the security key for the target SN is calculated based on an MN security key and a first unused sk-counter in an sk-counter list included in the LTM configuration. Process 600 may further involve processor 512 removing the first unused sk-counter from the sk-counter list. Also, process 600 may involve processor 512 calculating another security key for another SN based on a second unused sk-counter in the sk-counter list.

In some implementations, process 600 may involve processor 512 receiving, via transceiver 516, an indication indicating whether a candidate SN belongs to a different CU.

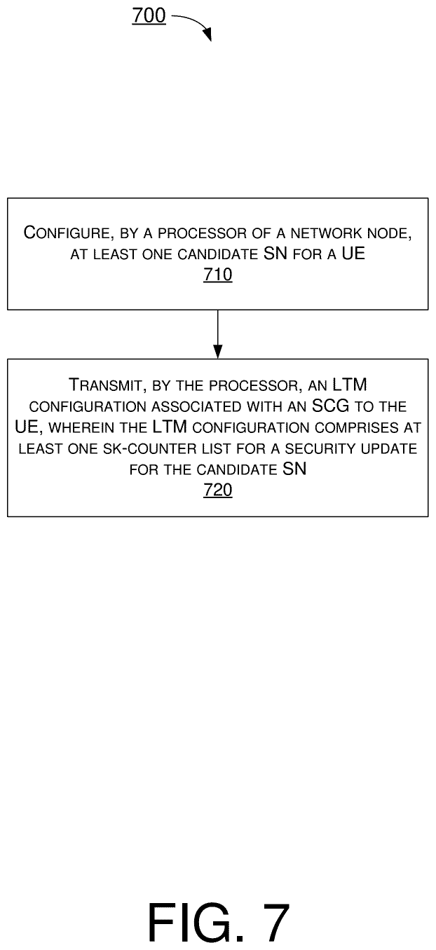

FIG. 7 illustrates an example process 700 in accordance with an implementation of the present disclosure. Process 700 may be an example implementation of above scenarios/schemes, whether partially or completely, with respect to security update for SCG LTM in inter-CU scenario in mobile communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any base stations or network nodes. Solely for illustrative purposes and without limitation, process 700 is described below in the context of network apparatus 520. Process 700 may begin at block 710.

At block 710, process 700 may involve processor 522 of network apparatus 520 configuring at least one candidate SN for a UE (e.g., communication apparatus 510). Process 700 may proceed from 710 to 720.

At block 720, process 700 may involve processor 522 transmitting, via transceiver 526, an LTM configuration associated with an SCG to the UE. The LTM configuration may include at least one sk-counter list for a security update for the candidate SN.

In some implementations, process 700 may further involve processor 522 transmitting, via transceiver 526, an indication indicating whether a candidate SN belongs to a different CU.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a layer1/layer2 triggered mobility (LTM) configuration associated with a secondary cell group (SCG) from a network node;
obtaining, by the processor, a security key for a target secondary node (SN), wherein the security key for the target SN is calculated based on the LTM configuration; and
transmitting, by the processor, at least one message encrypted with the security key to the target SN.

2. The method of claim 1, wherein the LTM configuration comprises one sk-counter list associated with one or more candidate SNs.

3. The method of claim 1, wherein the LTM configuration comprises at least one sk-counter list, and each of the at least one sk-counter list is associated with one candidate SN.

4. The method of claim 1, wherein the security key for the target SN is calculated based on a master node (MN) security key and one sk-counter selected from an sk-counter list included in the LTM configuration.

5. The method of claim 4, wherein the selected sk-counter is a first unused sk-counter in the sk-counter list.

6. The method of claim 1, further comprising:
calculating, by the processor, a plurality of security keys for a plurality of candidate SNs during an LTM preparation stage; and
storing, by the processor, the plurality of security keys,
wherein the security key for the target SN is obtained from the stored plurality of security keys.

7. The method of claim 1, wherein the obtaining of the security key for the target SN further comprises:
calculating, by the processor, the security key for the target SN in an event that receiving an SCG LTM cell switch command from the network node.

8. The method of claim 7, wherein the security key for the target SN is calculated based on a master node (MN) security key and a first unused sk-counter in an sk-counter list included in the LTM configuration, the method further comprises:
removing, by the processor, the first unused sk-counter from the sk-counter list; and
calculating, by the processor, another security key for another SN based on a second unused sk-counter in the sk-counter list.

9. The method of claim 1, further comprising:
receiving, by the processor, an indication indicating whether a candidate SN belongs to a different central unit (CU).

10. An apparatus, comprising:
a transceiver which, during operation, communicates wirelessly; and
a processor communicatively coupled to the transceiver such that, during operation, the processor performs operations comprising:
receiving, via the transceiver, a layer1/layer2 triggered mobility (LTM) configuration associated with a secondary cell group (SCG) from a network node;
obtaining a security key for a target secondary node (SN), wherein the security key for the target SN is calculated based on the LTM configuration; and
transmitting, via the transceiver, at least one message encrypted with the security key to the target SN.

11. The apparatus of claim 10, wherein the LTM configuration comprises one sk-counter list associated with one or more candidate SNs.

12. The apparatus of claim 10, wherein the LTM configuration comprises at least one sk-counter list, and each of the at least one sk-counter list is associated with one candidate SN.

13. The apparatus of claim 10, wherein the security key for the target SN is calculated based on a master node (MN) security key and one sk-counter selected from an sk-counter list included in the LTM configuration.

14. The apparatus of claim 13, wherein the selected sk-counter is a first unused sk-counter in the sk-counter list.

15. The apparatus of claim 10, wherein, during operation, the processor further performs operations comprising:
calculating a plurality of security keys for a plurality of candidate SNs during an LTM preparation stage; and
storing the plurality of security keys,
wherein the security key for the target SN is obtained from the stored plurality of security keys.

16. The apparatus of claim 10, wherein the obtaining of the security key for the target SN further comprises:
calculating the security key for the target SN in an event that receiving an SCG LTM cell switch command from the network node.

17. The apparatus of claim 16, wherein the security key for the target SN is calculated based on a master node (MN) security key and a first unused sk-counter in an sk-counter list included in the LTM configuration, and during operation, the processor further performs operations comprising:
removing the first unused sk-counter from the sk-counter list; and
calculating another security key for another SN based on a second unused sk-counter in the sk-counter list.

18. The apparatus of claim 10, wherein, during operation, the processor further performs operations comprising:
receiving, via the transceiver, an indication indicating whether a candidate SN belongs to a different central unit (CU).

19. A method, comprising:
configuring, by a processor of a network node, at least one candidate secondary node (SN) for a user equipment (UE); and
transmitting, by the processor, a layer1/layer2 triggered mobility (LTM) configuration associated with a secondary cell group (SCG) to the UE, wherein the LTM configuration comprises at least one sk-counter list for a security update for the candidate SN.

20. The method of claim 19, further comprising:
transmitting, by the processor, an indication indicating whether a candidate SN belongs to a different central unit (CU).
